(19) United States
(12) Patent Application Publication
(10) Pub. No.: US 2025/0361075 A1
(43) Pub. Date: Nov. 27, 2025

(54) SANITARY BAG DISPENSING DEVICE

(71) Applicant: Buffy Hopkins, Burbank, CA (US)

(72) Inventor: Buffy Hopkins, Burbank, CA (US)

(21) Appl. No.: 19/218,043

(22) Filed: May 23, 2025

Related U.S. Application Data
(60) Provisional application No. 63/651,175, filed on May 23, 2024.

(51) Int. Cl. B65D 83/08

(52) U.S. Cl. CPC B65D 83/0835; B65D 83/0888

(57) ABSTRACT

A sanitary bag dispensing device is disclosed herein. The sanitary bag dispensing device includes a housing, a dispensing portion and a disposal portion. In some versions, the housing can include a cuboidal for placement in a public bathroom. In other versions, the housing can include a cylindrical configuration for placement in a private bathroom. The dispensing portion may dispense sanitary bags, that are compostable and scented, and able to be used for placing sanitary products such as sanitary napkins, tampons, wipes, tissues, etc. therein for disposal thereof. The sanitary product within the sanitary bag can then be placed into the disposal portion of the sanitary bag dispensing device.

### CROSS-REFERENCE TO RELATED APPLICATION

The present application is related to and claims priority to U.S. Provisional Patent Application No. 63/651,175 filed May 23, 2024, which is incorporated by reference herein in its entirety.

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### FIELD OF THE INVENTION

The present invention generally relates to the field of dispensers and more specifically relates to a dispenser device for dispensing sanitary bags for use in disposal of sanitary products.

### DESCRIPTION OF RELATED ART

Disposable sanitary products, such as sanitary pads and tampons, have been the traditional go-to option for managing menstrual flow for many women. These products offer convenience and ease of use, as they are readily available in most stores and can be conveniently disposed of after use.

Sanitary pads, often referred to as sanitary napkins, are absorbent materials worn inside underwear to absorb menstrual blood. They come in various sizes, thicknesses, and absorbencies to accommodate different flow levels and body shapes. Tampons, on the other hand, are inserted into the vaginal canal to absorb menstrual blood internally. They are compact and discreet, offering freedom of movement during physical activities. The disposability of these products eliminates the need for washing and maintenance, making them a convenient choice for women with busy lifestyles.

In addition to sanitary products designed specifically for managing menstruation, there are various other personal care items that play essential roles in maintaining hygiene and cleanliness.

For example, tissues and wipes are two such products that are commonly used for a range of purposes beyond menstrual care. Tissues, typically made from soft paper materials, are widely used for wiping and cleaning purposes, including blowing the nose, wiping away tears, and cleaning surfaces. They are available in various sizes and thicknesses to suit different needs, from small pocket-sized packs for on-the-go use to larger boxes for home or office use.

Wipes, including baby wipes, facial wipes, and disinfecting wipes, are pre-moistened cloths designed for cleaning and sanitizing various surfaces, including skin.

Baby wipes are often used for diaper changes and general cleaning of infants and young children, while facial wipes are popular for makeup removal and refreshing the skin as disinfecting wipes contain antibacterial or antiviral agents and are commonly used for cleaning and sanitizing surfaces to reduce the spread of germs and pathogens.

While products like pads, tampons, and wipes may seem convenient to flush down the toilet, doing so can have serious consequences for plumbing systems and the environment.

These items are not designed to disintegrate quickly like toilet paper, leading to blockages in sewage pipes and sewer systems. When flushed, sanitary products and wipes can accumulate in sewer pipes, causing clogs and backups that require costly repairs and maintenance.

In addition to the inconvenience and expense for homeowners and establishment owners, these blockages can also lead to overflows of raw sewage into waterways, posing health risks and environmental harm.

Furthermore, even if these products make it through the household plumbing system without causing a blockage, they can still wreak havoc on wastewater treatment facilities. Sanitary products and wipes do not break down easily in water and can accumulate in screens and filters at treatment plants, causing equipment malfunctions and increased operating costs.

Additionally, the accumulation of non-biodegradable materials can interfere with the treatment process, reducing the efficiency of wastewater treatment and potentially releasing pollutants into the environment.

Disposing of sanitary products, tissues, and wipes in the trash is often the only viable option to avoid damaging plumbing systems and causing environmental harm.

However, this method of disposal presents its own set of challenges. Placing used products in the trash can be unsightly, particularly in shared spaces such as public restrooms or household bathrooms. The sight of used sanitary items and tissues can be unpleasant for others and may contribute to feelings of discomfort or embarrassment.

Moreover, the accumulation of used products in trash bins can create odors and attract pests if not emptied regularly, further exacerbating the issue.

Additionally, disposing of these items in the trash can raise concerns about hygiene, especially if the products are not properly covered or sealed. Uncovered trash bins containing used sanitary products, tissues, and wipes can pose a risk of exposure to bacteria, viruses, and other pathogens, particularly in high-traffic areas. This can be a significant concern in public restrooms, where multiple individuals may come into contact with the same trash bins.

Proper disposal of sanitary products, tissues, and wipes in the trash remains essential for preserving plumbing systems, protecting the environment, and promoting public health and hygiene.

Accordingly, a suitable solution is desired.

### BRIEF SUMMARY OF THE INVENTION

The present invention is directed to a sanitary bag dispensing device. The sanitary bag dispensing device advantageously addresses the aforementioned deficiencies by providing a sanitary bag dispensing device that is adapted for placement in a bathroom and used to dispense sanitary bags for disposal of sanitary products, such as sanitary napkins, tampons, wipes, tissues, etc. Thus, the aforementioned problems associated with the disposal of these items are avoided.

In a first implementation of the invention, a sanitary bag dispensing device comprises a housing having a dispensing portion and a disposal portion.

In some embodiments, the housing may include a cuboidal. In this configuration, the housing may include a housing top side, a housing bottom side opposite the housing top side, a housing front side, a housing rear side opposite the housing front side, a housing left side and a housing right side opposite the housing left side.

In another aspect, the dispensing portion and the disposal portion may be attached to and located adjacent each other.

The housing top side may be defined by two separate openable lids acting as lids for each of the dispensing portion and the disposal portion. For example, the dispensing portion may include a dispensing portion lid and the disposal portion may include a disposal portion lid.

In another aspect, the dispensing portion lid and the disposal portion lid may be hinged to the dispensing portion and the disposal portion, respectively. Particularly, the dispensing portion lid and the disposal portion lid may be hinged to the housing rear side.

In another aspect, the dispensing portion may include a dispensing portion interior sized to hold a plurality of sanitary bags. For example, the dispensing portion interior may be configured to hold a plurality of rolls of sanitary bags.

In another aspect, the dispensing portion may include a dispensing portion opening located at the housing front side, spanning therefrom into the dispensing portion interior.

The dispensing portion opening may be configured to dispense the sanitary bags therethrough. As such, a leading bag of one of the plurality of rolls of sanitary bags may be inserted, from the dispensing portion interior, through the dispensing portion opening such that a user is able to pull the leading bag from the dispensing portion opening.

Each of the sanitary bags may be attached to an adjacent sanitary bag via perforations such that removal of one of the sanitary bags automatically pulls the adjacent sanitary bag through the dispensing portion opening.

In another aspect, the dispensing portion lid of the dispensing portion may include a lock able to lock the dispensing portion lid to the dispensing portion, thereby preventing access to the dispensing portion interior of the dispensing portion.

In another aspect, the disposal portion of the housing may include a disposal portion interior configured to receive disposed of sanitary bags.

As such, once the user removes a sanitary bag from the dispensing portion of the housing, the user may place their sanitary product into the sanitary bag, seal the sanitary bag (for example, by tying the open end of the sanitary bag) and insert the sanitary bag into the disposal portion interior of the disposal portion.

In another aspect, the disposal portion may include indicia for indicating that the disposal portion is able to accept disposed of sanitary bags. For example, the indicia may include a garbage can image on an exterior of the housing front side at the disposal portion.

In some embodiments, the housing may include a cylindrical configuration. In this version, the housing may include the housing top side, the housing bottom side opposite the housing top side and a cylindrical wall between the housing top side and the housing bottom side.

In another aspect, the dispensing portion and the disposal portion may be attached to and stacked to each other. For example, the dispensing portion may be attached atop the disposal portion.

In another aspect, the housing top side may define the dispensing portion lid, enabling access into the dispensing portion interior of the dispensing portion.

In another aspect, the housing bottom side may define the disposal portion lid, enabling access into the disposal portion interior of the disposal portion.

As has been discussed above, the dispensing portion lid and the disposal portion lid may be hinged to the dispensing portion and the disposal portion, respectively.

In another aspect, the dispensing portion opening may be located within the dispensing portion at the cylindrical wall of the housing, spanning therefrom into the dispensing portion interior. As above, the dispensing portion opening may include an oval or oblong-like configuration.

Further, as above, the disposal portion may include the indicia for indicating that the disposal portion is able to accept disposed of sanitary bags.

In another aspect, the housing may be provided in a variety of colors, designs, etc. to match the décor of the bathroom it is placed in.

In another aspect, the plurality of sanitary bags may be compostable and scented.

These and other objects, features, and advantages of the present invention will become more readily apparent from the attached drawings and the detailed description of the preferred embodiments, which follow.

### BRIEF DESCRIPTION OF THE DRAWINGS

The preferred embodiments of the invention will hereinafter be described in conjunction with the appended drawings provided to illustrate and not to limit the invention, where like designations denote like elements, and in which:

FIG. 1 presents a front perspective view of a sanitary bag dispensing device including a cuboidal, according to one or more embodiments of the present invention;

FIG. 2 presents a front perspective view of the sanitary bag dispensing device including the cuboidal and including a plurality of sanitary bags in a dispensing portion of the sanitary bag dispensing device, according to one or more embodiments of the present invention;

FIG. 3 presents a front view of the sanitary bag dispensing device including the cylindrical configuration, according to one or more embodiments of the present invention;

FIG. 4 presents a front perspective view of the sanitary bag dispensing device including the cylindrical configuration and including a plurality of sanitary bags in the dispensing portion of the sanitary bag dispensing device, according to one or more embodiments of the present invention, according to one or more embodiments of the present invention; and

FIG. 5 presents a front view of the sanitary bag dispensing device including the cylindrical configuration with a disposal portion lid of a disposal portion being open, according to one or more embodiments of the present invention.

Like reference numerals refer to like parts throughout the several views of the drawings.

### DETAILED DESCRIPTION

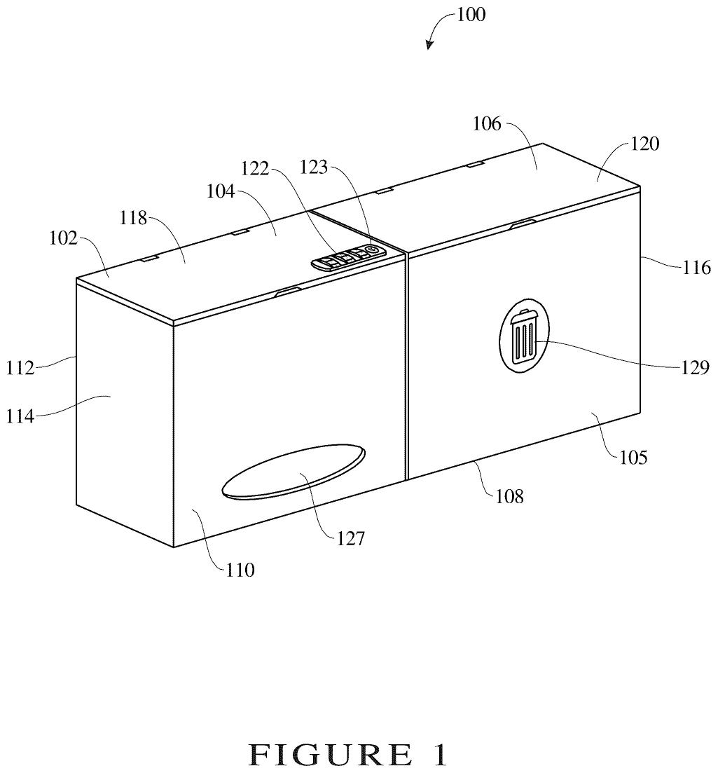

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended to limit the scope of the disclosure, which is defined by the claims. For purposes of description herein, the terms “upper”, “lower”, “left”, “rear”, “right”, “front”, “vertical”, “horizontal”, and derivatives thereof shall relate to the invention as oriented in FIG. 1. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

It should be appreciated that the term “comprising” can also encompass the terms “consisting essentially of” and “consisting of”.

Shown throughout the figures, the present invention is directed toward a sanitary bag dispensing device. The sanitary bag dispensing device may be placed in a bathroom, such as a public bathroom or a private bathroom. The sanitary bag dispensing device may dispense sanitary bags that can be used for placement of sanitary products therein, such as sanitary napkins, tampons, wipes, tissues, etc. to enable easy, clean and hygienic disposal thereof.

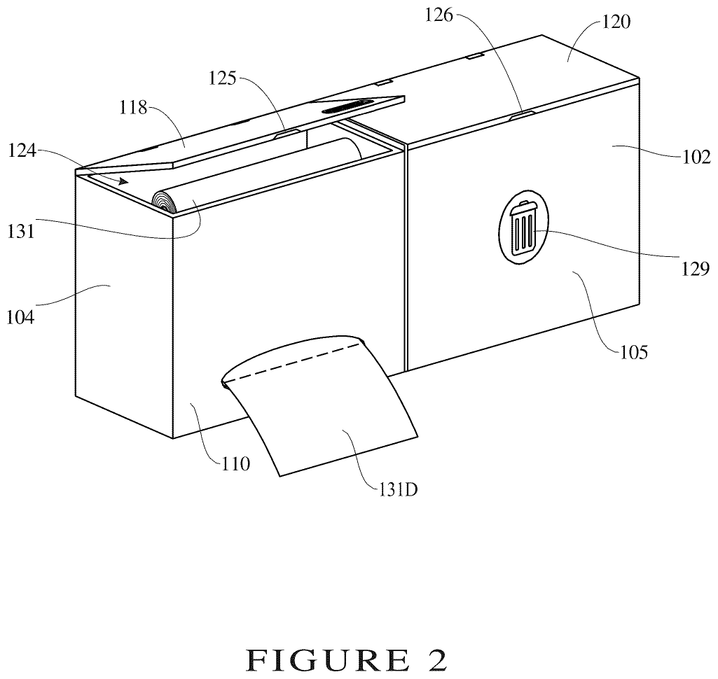

Referring initially to FIGS. 1-2, there is shown front perspective views of a sanitary bag dispensing device 100, according to one or more embodiments of the present disclosure. As shown here, in some embodiments, the sanitary bag dispensing device 100 may include a cuboidal. In some embodiments, the cuboidal of the sanitary bag dispensing device 100 may be configured for placement in a public bathroom.

In particular, the sanitary bag dispensing device 100 may include a housing 102 having a dispensing portion 104 and a disposal portion 105. In the cuboidal shown in FIGS. 1-2, the housing 102 may include a housing top side 106, a housing bottom side 108 opposite the housing top side 106, a housing front side 110, a housing rear side 112 opposite the housing front side 110, a housing left side 114 and a housing right side 116 opposite the housing left side 114.

As shown here, in this configuration, the dispensing portion 104 and the disposal portion 105 may be attached to and located adjacent each other.

The housing top side 106 may be defined by two separate openable lids acting as lids for each of the dispensing portion 104 and the disposal portion 105. For example, the dispensing portion 104 may include a dispensing portion lid 118 and the disposal portion 105 may include a disposal portion lid 120.

As shown in FIG. 1 in particular, the dispensing portion lid 118 of the dispensing portion 104 may include a lock 122 able to lock 122 the dispensing portion lid 118 to the dispensing portion 104, thereby preventing access to the dispensing portion interior 124 of the dispensing portion 104. For example, in some embodiments, the lock 122 may include a number combination lock 122 including a key slot 123 for receiving a key possessed by an owner of the bathroom. This may be particularly useful for public bathrooms.

As shown in FIG. 2, the dispensing portion lid 118 and the disposal portion lid 120 may be hinged to the dispensing portion 104 and the disposal portion 105, respectively. Particularly, the dispensing portion lid 118 and the disposal portion lid 120 may be hinged to the housing rear side 112 and able to pivot relative thereto to provide access into a dispensing portion interior 124 of the dispensing portion 104.

As shown in FIGS. 1-2, the dispensing portion lid 118 and the disposal portion lid 120 may each include a dispensing portion notch 125 and a disposal portion notch 126, respectively. The dispensing portion notch 125 and the disposal portion notch 126 may provide improved grip on the dispensing portion lid 118 and the disposal portion lid 120, respectively, enabling the user to easily open the dispensing portion lid 118 and the disposal portion lid 120.

In some embodiments, the housing 102 including the rectangular embodiment may be provided in various sizes. For example, in one version, the housing 102 may include (but is not limited to) a 7 inch×3 inch cuboidal configured to hold 6 rolls of sanitary bags 131 stacked atop each other.

In another example, the housing 102 may include (but is not limited to) a 4 inch×5 inch cuboidal configured to hold 6 rolls of sanitary bags 131 with 3 rows of 2 bags arranged in a side-by-side formation. In some embodiments, the plurality of sanitary bags 131 may be compostable and scented.

As shown in FIG. 1 in particular, the dispensing portion 104 may include a dispensing portion opening 127 located at the housing front side 110, spanning therefrom into the dispensing portion interior 124. In some examples, as shown here, the dispensing portion opening 127 may be located at the housing bottom side 108. Further, in some examples, the dispensing portion opening 127 may include an oval or oblong-like configuration, enabling easy removal of sanitary bags 131 therefrom. It should however be appreciated that the dispensing portion opening 127 is not limited to a particular location on the housing 102, nor is it limited to a particular configuration.

As shown in FIG. 2, the dispensing portion 104 may include the dispensing portion interior 124 sized to hold a plurality of sanitary bags 131. For example, the dispensing portion interior 124 may be configured to hold a plurality of rolls of sanitary bags 131.

The dispensing portion opening 127 may be configured to dispense the sanitary bags 131 therethrough. As such, a leading sanitary bag 131 a of one of the plurality of rolls of sanitary bags 131 may be inserted, from the dispensing portion interior 124, through the dispensing portion opening 127 such that a user is able to pull the leading sanitary bag 131 a from the dispensing portion opening 127. Each of the sanitary bags 131 may be attached to an adjacent sanitary bag 131 via perforations such that removal of one of the sanitary bags 131 automatically pulls the adjacent sanitary bag 131 through the dispensing portion opening 127.

Further, as shown in FIG. 2, the disposal portion 105 of the housing 102 may include a disposal portion interior 128 configured to receive disposed of sanitary bags 131. As such, once the user removes a sanitary bag 131 from the dispensing portion 104 of the housing 102, the user may place their sanitary product into the sanitary bag 131, seal the sanitary bag 131 (for example, by tying the open end of the sanitary bag 131) and insert the sanitary bag 131 into the disposal portion interior 128 of the disposal portion 105.

As shown in FIGS. 1-2, the disposal portion 105 may further include indicia 129 for indicating that the disposal portion 105 is able to accept disposed of sanitary bags 131. For example, the indicia 129 may include a garbage can image on an exterior of the housing front side 110 at the disposal portion 105.

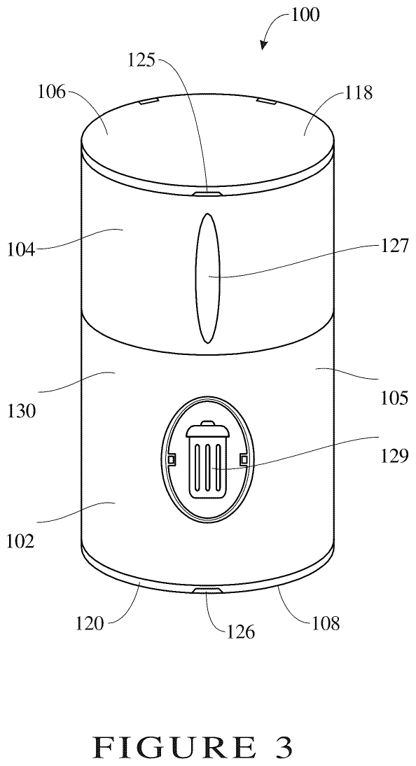

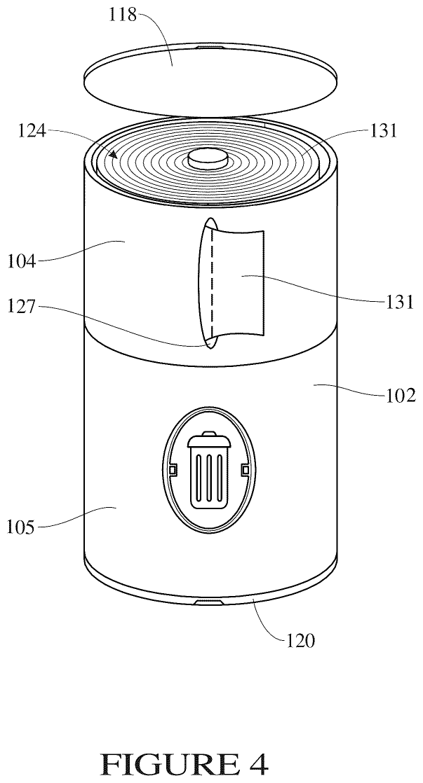

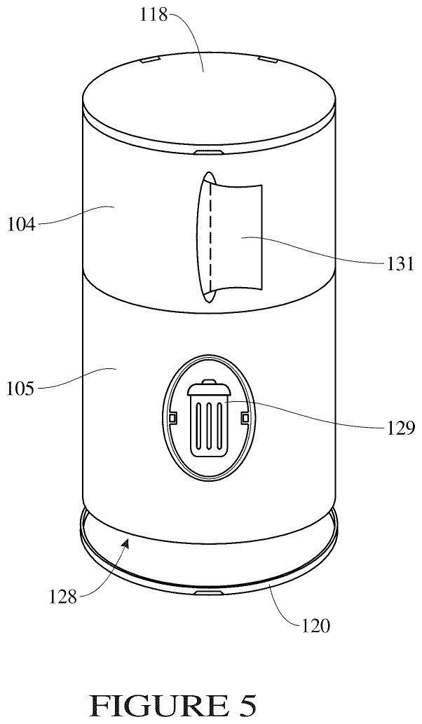

Referring now to FIGS. 3-5, there is shown the sanitary bag dispensing device 100, according to one or more other embodiments of the present disclosure. Particularly, as shown here, the housing 102 of the sanitary bag dispensing device 100 may include a cylindrical configuration. In this embodiment, the housing 102 may include the housing top side 106, the housing bottom side 108 opposite the housing top side 106 and a cylindrical wall 130 between the housing top side 106 and the housing bottom side 108.

In some embodiments, the cylindrical configuration of the sanitary bag dispensing device 100 may be configured for placement in a private bathroom. As such, the housing 102 may be provided in a variety of colors, designs, etc. to match the décor of the bathroom it is placed in.

As shown, in this embodiment, the dispensing portion 104 and the disposal portion 105 may be stacked. For example, the dispensing portion 104 may be attached atop the disposal portion 105. As such, the housing top side 106 may define the dispensing portion lid 118, enabling access into the dispensing portion interior 124 of the dispensing portion 104; and the housing bottom side 108 may define the disposal portion lid 120, enabling access into the disposal portion interior 128 of the disposal portion 105. As shown here, the dispensing portion lid 118 and the disposal portion lid 120 may be hinged to the dispensing portion 104 and the disposal portion 105, respectively.

In some embodiments, the housing 102 may be filled with the plurality of sanitary bags 131 from the housing bottom side 108. In some examples, in this embodiment illustrated in FIGS. 3-5, the housing 102 may be configured to hold 3 rolls of sanitary bags 131. Again, as above, the plurality of sanitary bags 131 may be compostable and scented.

The dispensing portion opening 127 may be located within the dispensing portion 104 at the cylindrical wall 130 of the housing 102, spanning therefrom into the dispensing portion interior 124. As above, the dispensing portion opening 127 may include an oval or oblong-like configuration. In this configuration, the dispensing portion opening 127 may span, generally, from about a top of the dispensing portion 104 to about a bottom of the dispensing portion 104. This configuration may provide easy access to the sanitary bags 131 and easy removal thereof.

In some embodiments, as has been discussed above and as shown here, the disposal portion 105 of this embodiment may further include the indicia 129 for indicating that the disposal portion 105 is able to accept disposed of sanitary bags 131.

In use, the user may load the plurality of sanitary bags 131 into the dispensing portion 104 of the housing 102 of the sanitary bag dispensing device 100 and may insert the sanitary bag 131 through the dispensing portion opening 127 such that the user is able to remove one of the sanitary bags 131. Once the sanitary bag 131 is removed, another sanitary bag 131 is moved through the dispensing portion opening 127. The user may then place their sanitary product into the sanitary bag 131 and place the sanitary bag 131 into the disposal portion interior 128 of the disposal portion 105.

Since many modifications, variations, and changes in detail can be made to the described preferred embodiments of the invention, it is intended that all matters in the foregoing description and shown in the accompanying drawings be interpreted as illustrative and not in a limiting sense. Furthermore, it is understood that any of the features presented in the embodiments may be integrated into any of the other embodiments unless explicitly stated otherwise. The scope of the invention should be determined by the appended claims and their legal equivalents.

What is claimed is new and desired to be protected by Letters Patent is set forth in the appended claims:

1. A sanitary bag dispensing device comprising:
a housing;
a dispensing portion compartment disposed in the housing, the dispensing portion compartment including a dispensing portion interior and a dispensing portion closure selectively closing the dispensing portion interior, the dispensing portion interior configured to hold a plurality of fresh sanitary bags; and
a disposal portion compartment disposed in the housing separate from the dispensing portion compartment, the disposal portion compartment including a disposal portion interior and a disposal portion closure selectively closing the disposal portion interior, the disposal portion interior configured to hold a plurality of used sanitary bags.

2. The sanitary bag dispensing device of claim 1, wherein the housing includes a cuboidal configuration, the housing including a housing top side, a housing bottom side opposite the housing top side, a housing front side, a housing rear side opposite the housing front side, a housing left side and a housing right side opposite the housing left side.

3. The sanitary bag dispensing device of claim 2, wherein the dispensing portion compartment is disposed at one of the housing left side and the housing right side of the housing, and wherein the disposal portion compartment is disposed at another of the housing left side and the housing right side of the housing.

4. The sanitary bag dispensing device of claim 3, wherein the dispensing portion closure includes a dispensing portion lid hingedly attached to the dispensing portion compartment at the housing rear side of the housing and wherein the disposal portion closure includes a disposal portion lid hingedly attached to the disposal portion compartment at the housing rear side of the housing.

5. The sanitary bag dispensing device of claim 1, wherein the housing includes a cylindrical configuration, the housing including a housing top side, a housing bottom side opposite the housing top side, a cylindrical wall disposed between the housing top side and the housing bottom side, a housing front side and a housing rear side opposite the housing front side.

6. The sanitary bag dispensing device of claim 5, wherein the dispensing portion compartment is disposed at one of the housing top side and the housing bottom side of the housing, and wherein the disposal portion compartment is disposed at another of the housing top side and the housing bottom side of the housing.

7. The sanitary bag dispensing device of claim 6, wherein the dispensing portion closure includes a dispensing portion lid hingedly attached to the dispensing portion compartment at the one of the housing top side and the housing bottom side and wherein the disposal portion closure includes a disposal portion lid hingedly attached to the disposal portion compartment at the another of the housing top side and the housing bottom side of the housing.

8. The sanitary bag dispensing device of claim 1, wherein the housing further includes a lock mechanism.

9. The sanitary bag dispensing device of claim 8, wherein the lock mechanism includes a combination lock.

10. The sanitary bag dispensing device of claim 8, wherein the lock mechanism includes a key slot.

11. The sanitary bag dispensing device of claim 8, wherein the lock mechanism is disposed on the dispensing portion closure of the dispensing portion compartment.

12. The sanitary bag dispensing device of claim 1, wherein the dispensing portion compartment further includes a dispensing portion opening disposed in a housing front side of the housing, the dispensing portion opening providing access to the plurality of fresh sanitary bags in the dispensing portion interior of the dispensing portion compartment for retrieval of at least one of the plurality of fresh sanitary bags.

13. The sanitary bag dispensing device of claim 1, wherein the disposal portion compartment includes indicia disposed at a housing front side of the housing.

14. The sanitary bag dispensing device of claim 13, wherein the indicia indicates use of the disposal portion compartment as a receptacle for used sanitary bags.

15. A sanitary bag dispensing device comprising:
a housing;
a dispensing portion compartment disposed in the housing, the dispensing portion compartment including a dispensing portion interior configured to hold a plurality of fresh sanitary bags, a dispensing portion lid selectively closing the dispensing portion interior, a dispensing portion opening disposed at a front side of the housing providing access to the plurality of fresh sanitary bags in the dispensing portion interior for retrieval of at least one of the plurality of fresh sanitary bags, and a lock mechanism disposed at the dispensing portion lid configured to prevent unauthorized opening thereof; and
a disposal portion compartment disposed in the housing separate from the dispensing portion compartment, the disposal portion compartment including a disposal portion interior and a disposal portion lid selectively closing the disposal portion interior, the disposal portion interior configured to hold a plurality of used sanitary bags.

16. The sanitary bag dispensing device of claim 15, wherein the lock mechanism includes a combination lock and a key slot.

17. The sanitary bag dispensing device of claim 15, wherein the disposal portion compartment includes indicia disposed at the housing front side of the housing, the indicia used to indicate use of the disposal portion compartment as a receptacle for used sanitary bags.

18. The sanitary bag dispensing device of claim 15, wherein the housing includes a cuboidal configuration, the housing including a housing top side, a housing bottom side opposite the housing top side, a housing front side, a housing rear side opposite the housing front side, a housing left side and a housing right side opposite the housing left side.

19. The sanitary bag dispensing device of claim 15, wherein the housing includes a cylindrical configuration, the housing including a housing top side, a housing bottom side opposite the housing top side, a cylindrical wall disposed between the housing top side and the housing bottom side, a housing front side and a housing rear side opposite the housing front side.

20. A method of using a sanitary bag dispensing device, the method comprising the steps of:
providing the sanitary bag dispensing device, the sanitary bag dispensing device comprising:
a housing;
a dispensing portion compartment disposed in the housing, the dispensing portion compartment including a dispensing portion interior holding a plurality of sanitary bags, a dispensing portion closure selectively closing the dispensing portion interior, and a dispensing portion opening providing access to the plurality of sanitary bags in the dispensing portion interior; and
a disposal portion compartment disposed in the housing separate from the dispensing portion compartment, the disposal portion compartment including a disposal portion interior and a disposal portion closure selectively closing the disposal portion interior;
removing at least one sanitary bag from the plurality of sanitary bags from the dispensing portion interior via the dispensing portion opening;
inserting a sanitary item into the at least one sanitary bag;
opening the disposal portion closure to access the disposal portion interior; and
placing the at least one sanitary bag into the disposal portion interior.
